(19) United States
(12) Patent Application Publication
(10) Pub. No.: US 2014/0037220 A1
(43) Pub. Date: Feb. 6, 2014

(54) IMAGE REPOSITORY SYSTEMS AND METHODS

(71) Applicants: Simon Phillips, York (GB); Mark Britten, London (GB); Mehdi Collinge, Braine-L'Alleud (BE)

(72) Inventors: Simon Phillips, York (GB); Mark Britten, London (GB); Mehdi Collinge, Braine-L'Alleud (BE)

(21) Appl. No.: 13/564,238

(22) Filed: Aug. 1, 2012

(51) Int. Cl. G06K 9/60; G06K 9/46

(52) U.S. Cl. 382/232; 382/306

(57) ABSTRACT

A service card image repository and directory is described. A process includes receiving a request to store at least one service image and related data, determining that the service image has been approved, and then uploading the service image and related data. The method also includes assigning a unique identifier to the service image and related data, and storing the service image and related data in an image repository. Some embodiments include receiving a request to download a service image and related data, locating the requested service image, determining that the requested service image requires transcoding and/or scaling, and then transcoding and/or scaling the requested service image to form a modified service image. The modified service image is then transmitted to an entity.

### BACKGROUND

Payment cards such as credit or debit cards are ubiquitous. Such cards include a magnetic stripe on which the relevant account number is stored. To consummate a purchase transaction with credit or debit card, the card is swiped through a magnetic stripe reader which is associated with a point of sale (POS) terminal. The magnetic stripe reader reads the account number from the magnetic strip and then routes a transaction authorization request to a payment card system which responds to the POS terminal.

In pursuit of greater convenience and more rapid transactions at POS terminals, payment cards have been developed that allow the account number to be automatically read from the card by radio frequency (RF) communication between the card and a proximity reader which may be incorporated with the POS terminal. Such cards are commonly known as “proximity payment cards” or “contactless payment cards”, and contain a radio frequency identification (RFID) integrated circuit (IC, often referred to as a “chip”) embedded in the card body. A suitable antenna is also embedded in the card body and is connected to the RFID chip to allow the chip to receive and transmit data by RF communication via the antenna. In typical arrangements, the RFID chip is powered from an interrogation signal which is transmitted by the proximity reader and received by the card antenna.

MasterCard International Incorporated, the assignee hereof, has established a widely-used standard, known as “PayPass”, for interoperability of contactless payment cards and proximity readers.

The capabilities of a contactless payment card have recently been incorporated into consumer mobile devices, such as mobile telephones, laptop computers, tablet computers, personal digital assistants (PDAs) and the like, thereby turning such devices into contactless payment devices. These consumer mobile devices capable of operating as contactless payment devices typically include integrated circuitry with the same functionality as the RFID IC of a contactless payment card. For example, a mobile telephone configured to operate as a contactless payment device includes a loop antenna that is coupled to a payment-related IC for use in sending and/or receiving messages in connection with a transaction that involves contactless payment. When a consumer wishes to pay for a purchase by utilizing his or her mobile telephone, the consumer typically first selects a payment account by using a mobile wallet graphical user interface (GUI). The mobile wallet GUI may display several primary account numbers (PANs) that each relate to a payment account so that the consumer can select which payment account to use in a purchase transaction. In some cases, one or more generic images of a credit or debit card that has been stored in memory on the mobile telephone may be displayed along with the PAN, and the generic image may indicate the type of credit card or debit card (for example, MasterCard™ or Visa™) associated with each PAN. After a selection is made, the consumer is typically directed to “tap” his or her phone near an RFID reader.

When a consumer wishes to pay for an online purchase, the consumer typically must enter his or her card details into the website payment application. The consumer may have already entered information associated with several different payment accounts into a particular retail website (such as Amazon.com), and thus he or she will have to identify which one of those payment accounts that he or she wishes to use. This is typically accomplished by the consumer reading the PAN appearing on the website page for each credit and/or debit card and then comparing those numbers to the physical credit or debit card. In some cases, the website may also display one or more generic images of a credit or a debit card alongside the PANs entered by the consumer, which generic images may indicate the type of credit card or debit card (for example, MasterCard™ or Visa™) associated with the PAN.

In the examples described above, when a consumer is shopping online, generic credit and/or debit card images may be displayed to aid the consumer in selecting an account to use to consummate a purchase transaction. However, the actual “look and feel” of the cardholder's payment card is lost in such generic images, because the generic images do not include many visual characteristics that are readily recognizable to the consumer. For example, various branding indications, logos, icons, text indicators, specific color combinations and the like, which are a key means of identification for the consumer, are not included in the generic images. Thus, the inventors recognized that it would be beneficial to provide an image service that would allow third party services, for example, to download the consumer's actual payment card image so that the consumer can quickly select the payment card account that he or she wishes to use for a particular purchase transaction. In the case of online shopping, such actual payment card images may graphically enhance the website of the retailer. The inventors also recognized that the concept could be expanded to include other types of service images for use by third parties and/or consumers, such as health benefits cards, loyalty program cards, transportation passes and the like.

### BRIEF DESCRIPTION OF THE DRAWINGS

FIG. 1 is a block diagram illustrating a service image repository system according to an embodiment of the invention;

FIG. 2 is a block diagram of web service components for a Card Image Repository according to an embodiment of the present invention;

FIG. 3 is a block diagram of a Resolution Service Server Computer according to an embodiment of the present invention;

FIG. 4 is a plan view of a mobile telephone (not drawn to scale) with a touch screen display component displaying an example screen display depicting a front side detailed card image in accordance with aspects of the present invention;

FIG. 5 is a flowchart illustrating an image uploading process of a resolution service computer according to an embodiment of the present invention; and

FIG. 6 is a flowchart illustrating an image downloading process of a resolution service computer according to an embodiment of the present invention.

### DETAILED DESCRIPTION

In general, and for the purpose of introducing concepts of embodiments of the present invention, described are methods and apparatus for an image service. In some embodiments, the image service includes a Resolution Service Computer that handles requests to store at least one service image and related data. In an implementation, the Resolution Service Computer is configured to determine a particular service image has been approved by a registered service provider, uploads the service image and related data, assigns a unique identifier to the service image and related data, and stores the service image and related data in an image repository. The Resolution Service Computer also may be configured to receive a request to download a service image and related data, to locate the requested service image and related data, to determine that the requested service image requires transcoding and/or scaling, to perform one or both such operations to generate a modified service image, and then to transmit the modified service image to an entity such as a website or consumer device.

Such operation allows, for example, an electronic device to retrieve a detailed image of the brand that relates to the service, or to otherwise retrieve a detailed image of the service. In some embodiments, the detailed image is provided to a user who may be utilizing a mobile electronic device such as a cell phone, laptop computer, tablet computer, eBook, e-Reader, personal digital assistant (PDA) and the like, or may be using another type of electronic device such as a desktop computer. For example, a user (such as a consumer and/or a cardholder) of a tablet computer may type in a payment card account number or primary account number (PAN) while initiating a purchase transaction on a retailer website. Once the payment card account number is entered, a detailed image of the user's payment card that corresponds to that payment card account number or PAN is caused to appear on the screen of the tablet computer. The detailed image may include easily identifiable characteristics such as, for example, a logo or icon identifying the type of credit or debit card associated with the PAN, one or more background images, identifying text (which may identify the issuer financial institution (FI), for example), a color scheme applicable to a particular credit or debit card issued by a particular bank, a partial or full PAN, and/or an expiry date. The data processing involved in obtaining and/or delivering and displaying the detailed image of the user's payment card on the electronic device is transparent to the user. Thus, the image service provides all of the necessary data to permit the user's electronic device to show a detailed image of a particular service provider (such as a bank-branded payment card, a retailer loyalty card, or a specific health care provider's card and the like) that is associated with the user, wherein previously only the identifying numbers of a payment account, and possibly a generic card image, were provided.

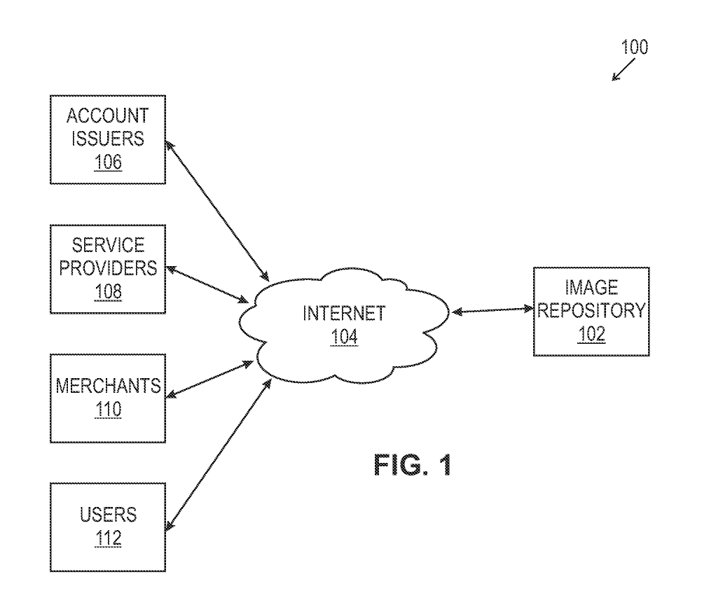

FIG. 1 is a block diagram illustrating a service image repository system 100 according to an embodiment. An Image Repository 102 is operably connected to the Internet 104 and configured for communicating with one or more of Account Issuers 106, Service Providers 108, Merchants 110, and Users 112. The Image Repository 102 and each of the other blocks depicted in FIG. 1 should be understood to represent the indicated entity, and also to represent one or more computers operated by the indicated entity. Thus, in addition to showing relationships amount the various parties that make up the image repository system 100, FIG. 1 also depicts a network of computers configured to exchange information for the purpose of implementing an image repository system. Although FIG. 1 illustrates an internet-based system, it should be understood that the system 100 could be implemented by utilizing other network configurations that enable communications between the Image Repository 102 and one or more of the various members of the system.

In some embodiments, the Image Repository 102 is a Card Image Repository managed by a service provider company such as MasterCard Worldwide, and may be a web service that allows Issuer FIs to upload approved card image data and related bank identification number (BIN) ranges for storage therein, and for retrieval and display of a particular detailed card image by users and/or merchants or others, for example, on electronic devices and/or on websites. Prior to uploading and/or storing one or more background card images, the image repository may require registration, for example, by an Issuer FI and proof of approval of the detailed image(s) from an entity such as a service provider (such as MasterCard International, Inc.). For example, branding personnel of a card issuer and/or a card service provider may first review a particular payment card design to ensure that it meets certain predetermined branding requirements, such as having a color scheme that does not conflict with and/or dilute a trademarked logo's color scheme that also appears as part of the card image. Such card image requirements may be included in a branding document or licensing agreement that was agreed to by the card issuer and a service provider, for example, and proof may consist of a copy of an approved BIN range document from the service provider or other type of approval indication from the service provider.

Once it has been determined that the background card images have been approved, an Issuer FI may then be permitted to upload the approved background card images and related bank identification number (BIN) ranges for storage in the Card Image Repository. The BIN includes a two-part code assigned to banks and savings associations. The first part of the BIN relates to a location and the second part identifies the bank itself. In an embodiment, each card image receives a Unique Card identifier (ID) when uploaded. In some embodiments, the Unique Card ID is added to the Card Layout Display (CLD) data already associated with a particular payment card account. The CLD data is provided along with other data during payment card personalization, which is a process that occurs at the end of the payment card manufacturing process wherein information, specific to each cardholder, is loaded onto the payment card and/or associated with the consumer's payment card account.

The CLD data can be read by a mobile device application which may use the Unique Card ID to request the detailed card image from the Card Image Repository. For example, a consumer utilizes her cell phone to initialize a purchase transaction. The cell phone transmits the Unique Card ID stored therein with a request to the Card Image Repository for a detailed card image. In this implementation, the Unique Card ID is used by the Card Image Repository to locate the proper payment card image and when found, the Card Image Repository transmits a Uniform Resources Locator (URL) to the mobile device. The URL is used by the cell phone to obtain (download) the detailed card image for display on the mobile device for the consumer. As will be explained below, additional parameters may also be included in the request for the detailed card image that pertain to the resolution and/or format and/or size of the detailed card image to ensure that the downloaded detailed card image will display correctly on the consumer's cell phone or other device.

In another example, during a payment transaction involving a consumer shopping on a merchant's website, the merchant may transmit a PAN entered by that consumer to the Card Image Repository. The PAN can be used to resolve the proper detailed card image by associating it with the correct BIN range that the Issuer FI furnished to the Card Image Repository for a particular Card Image. The data for the correct Card Image may then be transmitted from the Card Image Repository for display on the merchant's website for the consumer. In another example, a retail website may request a particular card image in the absence of a payment transaction by transmitting a request to the Card Image Repository that contains the PAN of a payment card account of a consumer who has registered with the merchant. In this case, a particular detailed card image can be returned from the Card Image Repository for that particular card's PAN. Such operation allows third party E-Commerce sites to use this image service to download their users' particular card images and then present the images to their customers on their website at a later time, such as during a purchase and/or checkout transaction. For example, a consumer shopping on a particular website typically selects items for purchase and descriptions of such items are placed in a virtual “shopping cart” for later checkout. Once the consumer indicates a willingness to pay for the items (for example, by clicking on a “Go to Virtual Shopping Cart” icon), the process includes presenting the consumer with payment options that typically include a choice between different brands of credit and/or debit cards, and in some cases, loyalty cards associated with that consumer. In accordance with aspects described herein, the website may transmit a request to the Card Image Repository to download detailed card image data that corresponds to detailed payment card images of one or more credit and/or debit cards and/or loyalty cards associated with that consumer for display during the checkout process. As mentioned above, many visual characteristics of payment cards are readily recognizable to the consumer. Thus, it is advantageous for a website to display detailed payment card images to consumers which include identifiers such as a full or partial PAN, an expiration date, a branding indication, a logo, an icon, text, specific color combinations and the like, to facilitate the identification of a payment card account for the consumer.

In some embodiments, the Card Image Repository is configured to process a request for a detailed Card Image by downloading one or more various resolutions and/or formats of a service image (such as a health card image or credit card image) for display by one or more devices. Different resolutions and/or formats may be stored by the Card Image Repository for any particular Card Image so that compatible detailed card image data may be provided for download to a variety of different devices, such as cell phones, laptop computers and tablet computers, for example. In addition, some image formats allow meta-data information to be added. In particular, Exchangeable Image File (EXIF) data could be utilized for some or all of the stored images, which permits extra meta-data to be added to certain file formats. (For example, digital cameras save JPEG files with EXIF data, which is useful to record attributes such as camera settings and scene information into the image file.) Other formats, such as Portable Network Graphics (PNG) which is a bitmapped image format employing lossless image compression, allow textual meta-data to be added in ancillary fields.

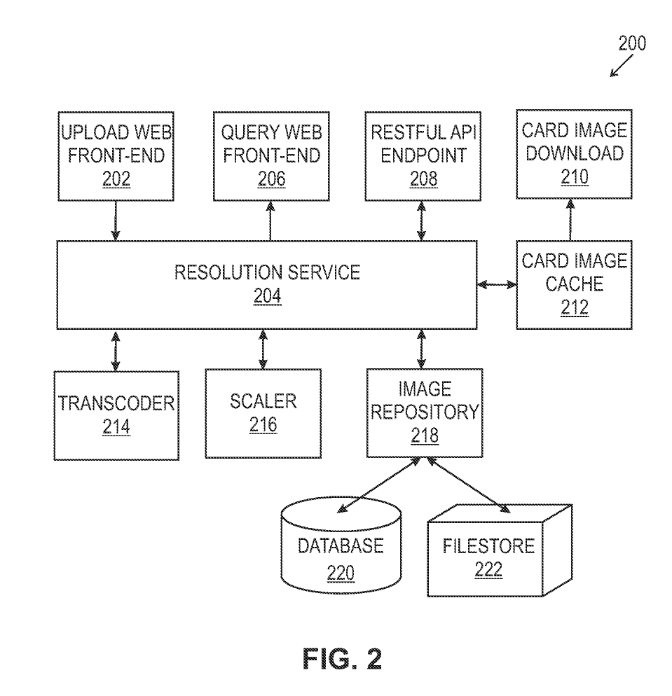

FIG. 2 is a block diagram of the Web Service Components 200 for a Card Image Repository according to an embodiment. The Resolution Service component 204 is a business logic component that functions to receive uploaded card images, to store the data related to the card images in the Database 220, and to store the card images in the Filestore 222. The Resolution Service component 204 also passes Meta-data that must be encoded into a Card Image to the Transcoder component 214, passes Card Images to be transcoded by the Transcoding component 214, and passes Card Images to be resized to the Image Scaler component 216. During operation, the Resolution Service component 204 may pass retrieved Card Images to the Card Image Cache 212 for quick downloading. In some embodiments, the Resolution Service component 204 also operates to generate a download URL for each Card Image to be downloaded from the Card Image Download component 210.

Referring again to FIG. 2, the Upload Web Front-end component 202 provides log-in and upload of web pages for the Resolution Service 204. The Query Front-end component 206 provides the form web pages that are utilized to request detailed card images from the Web Service. In some embodiments, a RESTful HTTP Application Programming Interface (API) Endpoint component 208, which is a Representational State Transfer (REST) HTTP interface that provides the programmatic interfaces for third parties into the Web Image Service, is utilized to allow for the uploading, querying and downloading of card images. (REST is a style of software architecture for distributed systems such as the Internet that has emerged as a predominant Web service design model due to its simpler style.) Such a RESTful HTTP interface can include an optimized protocol and thus may be particularly suited for use as an interface component for the Card Image Repository.

The Card Image Download component 210 show in FIG. 2 is the service that provides the Card Images for downloading, and operates to pull the requested detailed card image from the Card Image Cache component 212. The Card Image Cache component 212 is an in-memory storage medium for the card images that is utilized to speed the downloading of detailed card images. Also shown in FIG. 2 are the Transcoder component 214 which operates to convert a detailed card image into the format that has been requested, and an Image Scaler component 216 that functions to resize a detailed card image to the resolution requested. The Image Repository component 218 is a database component for storing the uploaded card images, and as mentioned above, it includes two components: a Database 220 that holds the structured data related to the card image and a Filestore 222 that holds the actual Card Image files. It should be understood, however, that certain details concerning the service card may not be stored in the Database 220 and/or the Filestore 222, such as the full PAN of a consumer's payment card account. Instead, such information may be stored locally, on the consumer's device, and accessed, for example, only to form the detailed card image on the consumer's device.

The Card Image repository of FIG. 2 may be utilized to provide improved service for card design management, and to provide an improved user experience. For example, when consumers utilize a mobile payment application, a mobile wallet, and/or other eCommerce solutions, such a service-based image repository is configured to rapidly recognize, select and provide an image associated with the consumers' service and/or card to display on the consumer's electronic device.

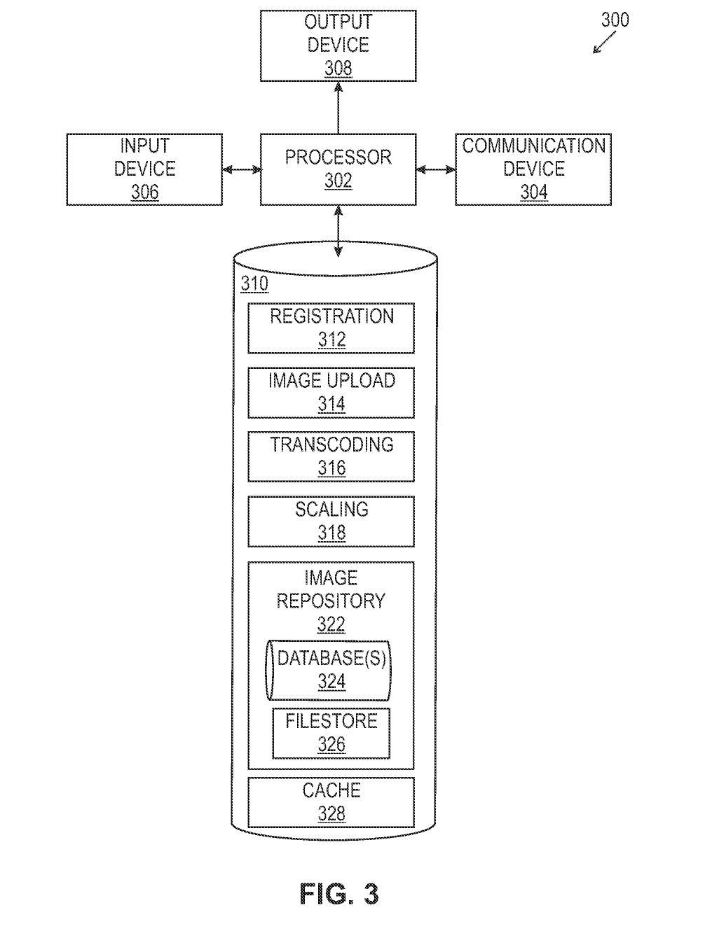

FIG. 3 is a block diagram of a Resolution Service Server Computer 300 according to an embodiment. The Resolution Service Server computer may be conventional in its hardware aspects but may be controlled by software to cause it to operate in accordance with aspects of the methods presented herein. In particular, the Resolution Service Server computer 300 may include a computer processor 302 operatively coupled to a communication device 304, an input device 306, an output device 308, and a storage device 310. However, it should be understood that, in some embodiments the Card Image Repository may include several server computers or a larger number of server computers that work together as part of a system to provide the service. In such a system, different portions of the overall service may be provided by one or more server computers in communication with one or more other server computers such that an appropriate scaling up of server computer availability may be provided if and/or when greater workloads, for example a large number of card image requests, are encountered.

The computer processor 302 may constitute one or more conventional processors. Processor 302 operates to execute processor-executable steps, contained in program instructions described herein, so as to control the Virtual Wallet Server computer 302 to provide desired functionality.

Communication device 304 may be used to facilitate communication with, for example, devices such as Account Issuer server computers, Service Provider server computers, Merchant server computers, and user devices. Communication device 304 may, for example, have capabilities for engaging in data communication over conventional computer-to-computer data networks, and/or may have wireless communications capability (for example, enabling the Resolution Service computer server to communicate directly with a cellular telephone operated by a consumer). Any such data communication may be in digital form and/or in analog form.

Input device 306 may comprise one or more of any type of peripheral device typically used to input data into a computer. For example, the input device 306 may include a keyboard, a computer mouse and/or a touchpad or touch screen. Output device 308 may comprise, for example, a display and/or a printer.

Storage device 310 may comprise any appropriate information storage device or computer readable medium, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium”.

Thus, it should be understood that the term “computer-readable medium” as used herein refers to any non-transitory storage medium that participates in providing data (e.g., instructions) that may be read by a computer, a processor or a like device. Such a medium may take many forms, including but not limited to, non-volatile media and volatile media. Non-volatile media may include, for example, optical or magnetic disks and other persistent memory. Volatile media may include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in providing sequences of instructions to a processor. For example, sequences of instruction (i) may be delivered from RAM to a processor, (ii) may be wirelessly transmitted, and/or (iii) may be formatted according to numerous formats, standards or protocols, such as Transmission Control Protocol, Internet Protocol (TCP/IP), Wi-Fi, Bluetooth, TDMA, CDMA, and 3G.

Referring again to FIG. 3, storage device 310 stores one or more programs for controlling the processor 302. The programs comprise program instructions that contain processor-executable process steps of the Resolution Service server computer 300, including, in some cases, process steps that constitute processes provided in accordance with principles of the processes presented herein.

The programs may include a Card Image Registration application 312 that manages a process by which third parties such as service providers, issuing financial institutions, and consumers (i.e., cardholders) may register themselves and/or their mobile devices, for example, with the Card Image Resolution Service server computer 300. In some embodiments, the registration process may allow the third parties to register by accessing, for example via their computer, mobile telephone or tablet computer (not shown), a suitable web page hosted by the Card Image Resolution server computer 300. The information gathered from the third party during the registration process may include BIN numbers and/or BIN ranges, partial or full payment card account number(s) (PANs), and/or mobile telephone number(s) (or other mobile identifiers). The registration process may also require a third party to provide and/or set up verification or authentication data that identifies that particular third party. A registered third party may be permitted to upload Card Images for storage in the Card Image repository 322, query the Card Image repository for one or more Card Images, and/or download a Card Image to, for example, a consumer electronic device such as a mobile telephone.

In addition or alternatively, the registration of third parties with the Resolution Service server computer 300 may be a batch process, for example, in which issuers of payment card accounts transfer payment card account image information to the Resolution Service server computer 100.

The storage device 310 may also store an image upload application 314, a transcoding application 316, a scaling application 318 and an image download application 320 for controlling the Resolution Service server computer 300 to provide for, respectively, receiving Card Images, for transcoding and scaling Card Images, and for transmitting requested Card Images, for example, to a consumer device and/or to a website for display.

Reference numeral 322 in FIG. 3 denotes an Image Repository that may include one or more databases 324 and a Filestore 326 that are maintained by the Resolution Services server computer 300 on the storage device 310. Among these databases may be, for example, an Image Database, a consumer database, a merchant database, an issuer FI database, and an acquirer FI database.

The application programs of the Virtual Wallet Server computer 300, as described above, may be combined in some embodiments, as convenient, into one, two or more application programs. Moreover, the storage device 310 may store other programs or applications, such as one or more operating systems, device drivers, database management software, web hosting software, and the like.

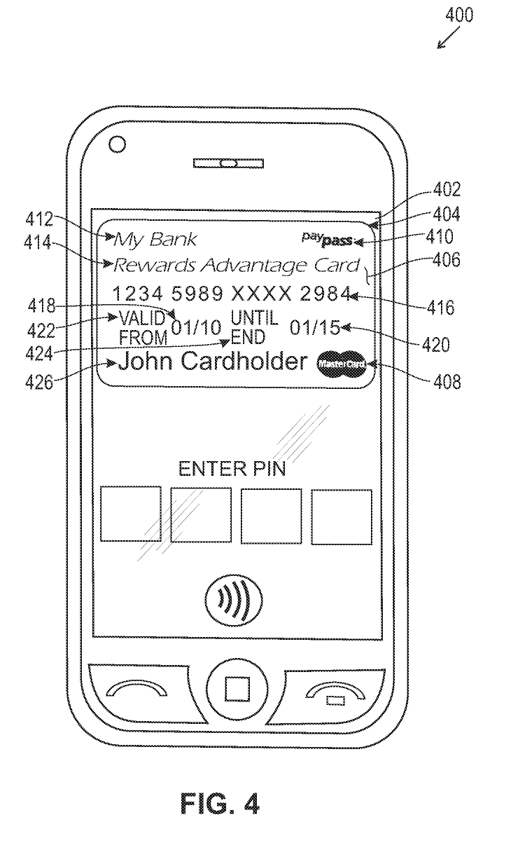

FIG. 4 is a plan view of a mobile telephone 400 (not drawn to scale) with a touch screen display component 402 that is displaying an example screen display of a front side detailed card image 404 of a consumer's payment card in accordance with aspects described herein. In this example, the front side image 404 represents the front side of a payment card (such as a credit card or a debit card) which has been issued by an issuer financial institution (FI) to the owner of the mobile telephone 400. As shown, the front side detailed card image 404 includes the following elements: (a) a background 406 that may be of a particular color or colors, and that may or may not have a particular design, (b) a payment association logo 408 (MasterCard International Inc., the assignee hereof, is a prominent example of a payment association), (c) a service logo 410 of the payment association, (d) the issuer's logo 412 (in this case, “MyBank”), (e) secondary branding text 414 (for example, “Rewards Advantage Card”) that may be provided by the issuer FI, (f) a full or partial payment card account number 416, (g) valid from and to expiration dates 418 and 420, respectively, (h) labeling text 422, 424 for the valid from and expiration dates, and (i) the cardholder's name 426. In some embodiments, the rear side payment card image may be accessible and/or also displayed to the user/cardholder (not shown), which may be important for payment cards that include features such as the card security code (CSC), sometimes referred to as the Card Verification Data (CVD), on the rear side of the payment card.

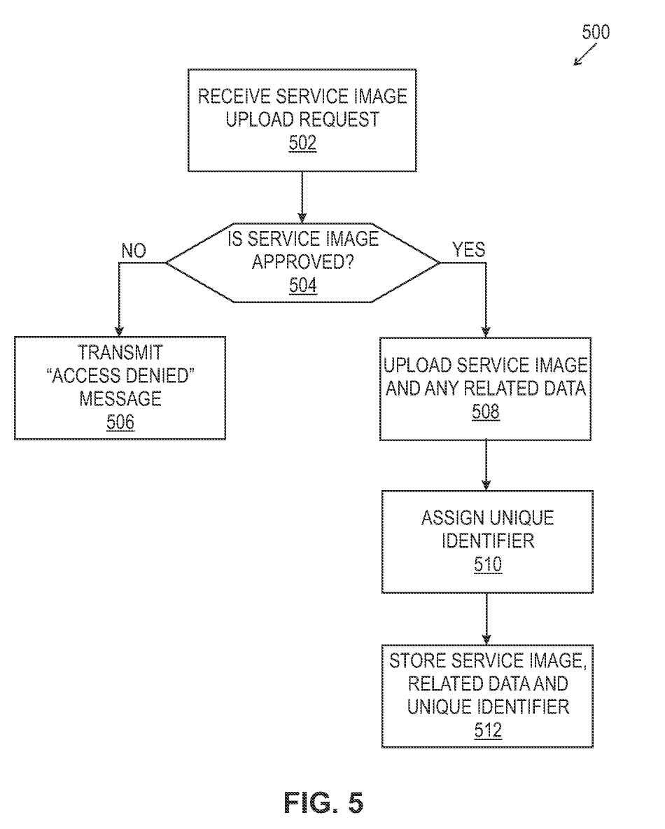

FIG. 5 is a flowchart illustrating an image uploading process 500 of a resolution service computer according to an embodiment. In particular, the resolution service computer receives 500 a request to store at least one service image and related data, and then determines 504 whether or not the service image(s) have been approved by a registered service provider, such as a credit card issuer FI. If not, the resolution services computer transmits 506 an “Access Denied” message to the registered service provider. But if the service image(s) have been approved, then the resolution services computer uploads 508 the service image(s) and related data and assigns 510 a unique identifier to each of the approved service images. Lastly, the resolution services computer stores 512 the service image(s), the related data, and the unique identifier in the image repository. Thus, when the consumer wishes to obtain one or more payment card account images associated with one or more of his or her accounts, the unique identifier (which may have been provided during a personalization process) will be transmitted to the resolution services computer to facilitate locating the requested service card image(s).

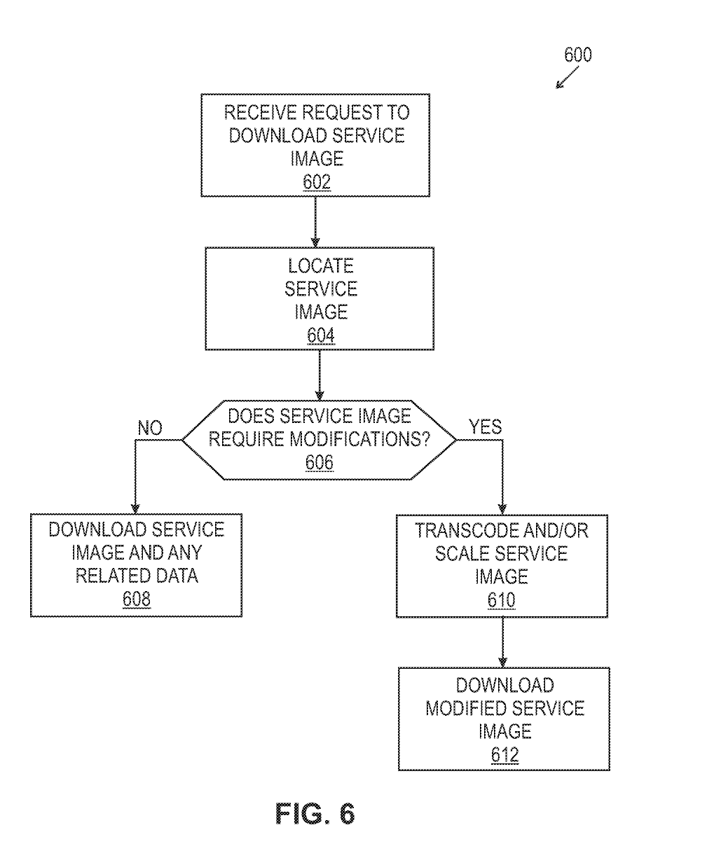

FIG. 6 is a flowchart illustrating an image downloading process 600 of a resolution service computer according to an embodiment. The resolution service computer receives 602 a request to download a service image and any related data. In some embodiments, the request includes a primary account number (PAN) or the unique identifier generated by the resolution service computer during an uploading process (as discussed above with regard to FIG. 5). Next, the resolution service computer locates 604, based on the PAN or the unique identifier, the requested service image and any related data and determines 606 whether or not the requested service image needs to be modified. If the requested service image data does not need to be modified, then the service resolution computer downloads 608 the requested service image and any related data to the requesting entity. However, if the resolution service computer determines 606, based on the related data, that the service image requires modification, then the service image transcoded and/or scaled 610, and the modified service image is downloaded 612 to the requesting entity. In some embodiments, the requesting entity is a third party website (such as a merchant's website, or a health care provider's website), or may be a consumer who owns one or more electronic devices.

In an embodiment, a centralized web service-based repository is provided by a service provider for the authorization, storage and retrieval of card and/or service images. Such a “Software as a Service” (SAAS)-based product allows payment card account Issuers (such as retailers, banks or credit unions), for example, to upload their approved card images and associated BIN ranges for use by approved third parties (such as merchants). The approved third parties can utilize the approved card image data to display one or more payment card images for a Cardholder (of payment cards that belong to the Cardholder) on the Cardholder's device. As described above, this is accomplished by the Resolution Service server computer which provides an upload web front-end and an API for querying the image database, and by providing transcoding and scaling services so that the Card Images can be displayed on a number of different devices. Parties such as Issuing Banks, Telephone Company Providers, Service Providers (such as health services providers) and E-Commerce sites can utilize the Resolution Service to provide Card Images for their customers that are substantially or exactly the same as the information shown on a particular customer's service card (such as a payment card), which information can be easily recognized and/or identified by the Cardholder. This is a substantial improvement over providing nothing more than the PAN or other service account number. The Resolution Service may charge a fee to third parties for uploading and/or storing detailed service card images, and/or for otherwise providing access to the database of Card Images.

The flow charts and descriptions appearing herein should not be understood to prescribe a fixed order of performing the method steps described therein. Rather the method steps may be performed in any order that is practicable.

As used herein and in the appended claims, the term “payment card account” includes a credit card account or a deposit account that the account holder may access, for example, by using a debit card. The term “payment card account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card). The term “payment card account” also includes an account to which a payment card account number is assigned. Thus, a payment card account may include an account to which payment transactions may be routed by a payment system that handles debit card and/or credit card transactions, even if the account in question is not eligible to be charged for purchase transactions or other transactions. A payment card account may also include an account from which payment transactions may be routed by a payment system that handles debit card and/or credit card transactions, even if the account in question is not customarily used, or is not eligible, to be charged for purchase transactions.

Although specific exemplary embodiments have been described herein, it should be understood that various changes, substitutions, and alterations apparent to those skilled in the art can be made to the disclosed embodiments without departing from the spirit and scope of the invention as set forth in the appended claims.

What is claimed is:

1. A method, comprising:
receiving, in a resolution service computer, a request to store at least one service image and related data;
determining, by the resolution service computer, that the at least one service image has been approved by a registered service provider;
uploading the at least one service image and related data;
assigning, by the resolution service computer, a unique identifier to the at least one service image and related data; and
storing the service image and related data in an image repository.

2. The method of claim 1, further comprising:
receiving, by the resolution service computer, a request to download a service image and related data, the request including at least one of a primary account number and the unique identifier;
locating, based on at least one of the primary account number and the unique identifier, the requested service image and related data;
determining, based on the related data, that the requested service image requires at least one of transcoding and scaling;
at least one of transcoding and scaling the requested service image to form at least one modified service image; and
transmitting, by the resolution service computer, the at least one modified service image to an entity.

3. The method of claim 2, wherein transmitting comprises the resolution service computer transmitting the modified service image to at least one of a merchant website and a consumer electronic device.

4. The method of claim 1, wherein the image repository comprises at least one database for storing the related data and a filestore for storing card image files.

5. The method of claim 4, wherein the image repository further comprises a high-speed cache for storing service image data.

6. The method of claim 1, further comprising transmitting the unique identifier to a consumer electronic device for storage with card layout display (CLD) data.

7. The method of claim 1, wherein the service images comprise payment card images and the related data comprises at least one BIN range.

8. The method of claim 1, wherein storing related data comprises storing at least one of a bitmap of a logo of an issuer of a service card, at least one position indicator for indicating a position in a front side service card image for the logo, a scaling factor for scaling the logo, color data specifying at least one fill color for the front side service card image, a bitmap of a payment association logo, a second position indicator for indicating a position in the front side service card image for the payment association logo, text and position information for labeling a valid from date and an expiration date for the service card, and text and position information for secondary text specified by a service card issuer for branding the service card apart from the logo.

9. The method of claim 1, further comprising storing, in a consumer electronic device, a reduced set of payment card image data.

10. The method of claim 9, wherein the reduced set of payment card image data comprises at least one full primary account number (PAN) associated with at least one payment card account of a consumer.

11. A non-transitory computer readable medium storing instructions configured to cause a processor to:
receive a request to store at least one service image and related data;
determine that the at least one service image has been approved by a registered service provider;
upload the at least one service image and related data;
assign a unique identifier to the at least one service image and related data; and
store the service image and related data in an image repository.

12. The non-transitory computer readable medium of claim 11, further comprising instructions configured to cause the processor to:
receive a request to download a service image and related data, the request including at least one of a primary account number and the unique identifier;
locate, based on at least one of the primary account number and the unique identifier, the requested service image and related data;
determine, based on the related data, that the requested service image requires at least one of transcoding and scaling;
at least one of transcode and scale the requested service image to form at least one modified service image; and
transmit the at least one modified service image to an entity.

13. The non-transitory computer readable medium of claim 12, wherein the instructions configured to cause the processor to transmit comprises instructions configured to cause the processor to transmit the at least one modified service image to at least one of a merchant website and a consumer electronic device.

14. The non-transitory computer readable medium of claim 11, wherein the instructions for storing comprise instructions configured to cause the processor to store the related data in a database and to store the card images in a filestore.

15. The non-transitory computer readable medium of claim 14, wherein the instructions for storing further comprise instructions configured to cause the processor to store the service image data in a high-speed cache.

16. The non-transitory computer readable medium of claim 11, further comprising instructions configured to cause the processor to transmit the unique identifier to a consumer electronic device for storage with card layout display (CLD) data.

17. The non-transitory computer readable medium of claim 11, wherein the instructions for receiving a request to store at least one service image and related data further comprise instructions configured to cause the processor to receive payment card images and at least one BIN range.

18. The non-transitory computer readable medium of claim 11, wherein the instructions for storing related data further comprise instructions configured to cause the processor to store at least one of a bitmap of a logo of an issuer of a service card, at least one position indicator for indicating a position in a front side service card image for the logo, a scaling factor for scaling the logo, color data specifying at least one fill color for the front side service card image, a bitmap of a payment association logo, a second position indicator for indicating a position in the front side service card image for the payment association logo, text and position information for labeling a valid from date and an expiration date for the service card, and text and position information for secondary text specified by a service card issuer for branding the service card apart from the logo.

19. An apparatus, comprising:
a processor;
a communications device operably connected to the processor; and
a storage device operably connected to the processor, the storage device storing instructions configured to cause the processor to:
receive a request to store at least one service image and related data;
determine that the at least one service image has been approved by a registered service provider;
upload the at least one service image and related data;
assign a unique identifier to the at least one service image and related data; and
store the service image and related data in an image repository.

20. A method, comprising:
receiving, by a resolution service computer, a request to download a service image and related data, the request including at least one of a primary account number and a unique identifier;
locating, based on at least one of the primary account number and the unique identifier, the requested service image and related data;
determining, based on the related data, that the requested service image requires at least one of transcoding and scaling;
at least one of transcoding and scaling the requested service image to form at least one modified service image; and
transmitting, by the resolution service computer, the at least one modified service image to an entity.

21. The method of claim 20, wherein the entity comprises at least one of a merchant website and a consumer electronic device.

22. A non-transitory computer readable medium storing instructions configured to cause a processor to:
receive a request to download a service image and related data, the request including at least one of a primary account number and a unique identifier;
locate, based on at least one of the primary account number and the unique identifier, the requested service image and related data;
determine, based on the related data, that the requested service image requires at least one of transcoding and scaling;
at least one of transcode and scale the requested service image to form at least one modified service image; and
transmit the at least one modified service image to an entity.

23. The non-transitory computer readable medium of claim 22, wherein the instructions configured to cause the processor to transmit comprises instructions configured to cause the processor to transmit the at least one modified service image to at least one of a merchant website and a consumer electronic device.

24. An apparatus, comprising:
a processor;
a communications device operably connected to the processor; and
a storage device operably connected to the processor, the storage device storing instructions configured to cause the processor to:
receive a request to download a service image and related data, the request including at least one of a primary account number and a unique identifier;
locate, based on at least one of the primary account number and the unique identifier, the requested service image and related data;
determine, based on the related data, that the requested service image requires at least one of transcoding and scaling;
at least one of transcode and scale the requested service image to form at least one modified service image; and
transmit the at least one modified service image to an entity.
